(19) United States
(12) Patent Application Publication
(10) Pub. No.: US 2010/0032373 A1
(43) Pub. Date: Feb. 11, 2010

(54) METHOD FOR THE OPTIMISED MANAGEMENT OF A MEMBRANE FILTRATION UNIT AND EQUIPMENT FOR REALISING THE SAME

(75) Inventor: Chrystelle Langlais, Le Pecq (FR)

Correspondence Address: CONNOLLY BOVE LODGE & HUTZ LLP, 1875 EYE STREET, N.W., SUITE 1100, WASHINGTON, DC, 20006, US

(73) Assignee: DEGREMONT, Rueil-Malmaison (FR)

(21) Appl. No.: 12/519,689

(22) PCT Filed: Dec. 14, 2007
(86) PCT No.: PCT/FR07/02074

§ 371 Date: Oct. 26, 2009

(30) Foreign Application Priority Data
Dec. 19, 2006 (FR) FR 0611072

(51) Int. Cl. C02F 1/52

(52) U.S. Cl. 210/637; 210/103

(57) ABSTRACT

The invention relates to a method for the optimised management of a membrane filtration unit based on membrane micro-coagulation, that comprises at least one measurement of the effluent temperature (7), one measurement of the filtration flow rate (8), and one measurement of the trans-membrane pressure (9). The injection of the coagulation reagent(s) is controlled by a unit (U) when the membrane permeability becomes lower than a threshold value, and the interruption of the coagulation reagent(s) injection is controlled when the membrane permeability is again equal to or higher than the stable LpO value before the drop, during a predetermined hold time.

The present invention relates to a method for the optimized management of a membrane filtration unit, according to the degree of fouling of the membrane and/or to the temperature, employing membrane microcoagulation according to the patent EP 1 239 943, resulting from patent application WO 01/41906, the proprietor of which is the Applicant.

Microcoagulation consists in injecting, upstream of the membrane, a dose of coagulant(s) 30 to 80 times lower than the coagulant dose bringing the zeta potential of the effluent to zero.

A major technical and economic challenge is to maintain the hydraulic performance of microfiltration, ultrafiltration, nanofiltration and hyperfiltration membranes for the treatment of liquids, such as especially surface water, wastewater and sea water.

Specifically, the hydraulic performance of a membrane is illustrated by its permeability, i.e. the rate of effluent passing through a unit area of membrane for a normalized pressure difference applied on either side of the membrane of 1 bar, at a given temperature. It is recalled that the initial permeability or Lpᵢ is the permeability of a fresh membrane measured on drinking water, the clogging index and the temperature of which must be known.

Apart from deterioration of the membrane structure, which is of no concern in the present invention, the two parameters that affect the hydraulic performance of a membrane are:
the temperature of the untreated effluent; and
the degree of clogging of the membrane.

### Temperature

The influence of temperature on the viscosity of an effluent, in particular water, is well known. Thus, a drop in temperature, by increasing the viscosity of the water, makes it more difficult for water to pass through a membrane. This therefore results in a drop in permeability at the temperature of the effluent. It should be noted that a 1° C. difference around 20° C., for example, results in a reduction of about 2.5% in flux for a given transmembrane pressure. This is a law of physics which can be but suffered by those skilled in the art.

From the industrial standpoint, this means that, for a given production rate, the treatment unit must be designed for the coldest temperature, that is to say, when this minimum temperature is less than 20° C., the installed membrane area must consequently be increased.

It should be noted that when comparing permeability measurements at different temperatures, a person skilled in the art has to determine correction factors for factoring out the effect of temperature. Thus, Lp(T_{ref})=K×Lp(T), where K is a function of the effluent temperature and the reference temperature T_{ref}. This reference temperature is usually set at 20° C. or 25° C.

### Clogging

For a person skilled in the art, the generic term “clogging”, well documented in the literature, refers to all of the phenomena that increase the resistance of the membrane, either mechanically or chemically. This covers surface deposition (cake formation) and adsorption on the membrane and in the pores of the membrane, and phenomena in which the various substances contained in the water, namely suspended matter, colloids and organic and mineral matter, are involved.

In fact, clogging involves:
either a reduction in filtration flux for a constant applied transmembrane pressure,
or an increase in the applied transmembrane pressure in order to keep the filtration flux constant.

In both cases, this clogging phenomenon results in a drop in permeability of the membrane, i.e. a reduction in technical-economic efficiency of the membrane.

For the rest of the description, the following are defined:
Lpᵢ: initial permeability of the membrane when it is first used; and
Lp₀: stabilized permeability under actual operating conditions, which may vary depending on, for example, the degree of membrane fouling.

Clogging control is therefore a major challenge clearly identified by those skilled in the art, who have proposed a raft of solutions (preventative measures) aimed at preventing clogging, but when clogging does occur it can be eliminated only by curative measures.

The curative measures essentially involve repeated chemical washing of the membrane, as explained in detail in the literature. These measures consist mainly in providing phases during which the membrane is brought into contact with a washing solution, which may contain one or more chemical reagents, such as acids and/or chelating agents, detergents, oxidizers, etc.

In all cases, these washing operations and the production stoppages that they entail, together with the resulting water wastage, means that the installation has to be overdesigned in order to maintain the nominal production throughput, incurring additional investment and running costs. Moreover, these washing operations, even though intended for membranes, are still aggressive operations that reduce the lifetime of membranes.

From the industrial standpoint, the triggering of these curative phases is controlled on the basis of a membrane clogging measurement, i.e. a measurement indicating that the permeability has dropped below a threshold, set for example by the membrane supplier. As a variant, these curative measures can be carried out for preventive purposes with a given frequency, for example ranging from once a month to once a year.

To limit the frequency of chemical washing, preventative measures have been described in the literature. They rely essentially on:
physical effects, such as the application of electric or ultrasonic fields;
hydrodynamic effects, either by creating unsteady conditions (two-phase flow, promotion of turbulence or swirling) or turbulent flow close to the surface of the membrane;
biological effects, with for example the use of enzymes; and, finally
chemical effects, either for modifying the surface of the membrane during the membrane manufacturing phase, or directly by addition of a reactant into the untreated effluent, so as to modify the structure of the treated matrix.

To be effective, all these preventive measures must be performed continuously or associated with judiciously chosen triggering factors, generally the quality of the effluent, in order to anticipate clogging. This is because, when clogging is observed (especially by an observed drop in permeability), the preventative measures are of no effect, and only the curative measures can restore the hydraulic performance of the membrane.

If the preventative measures are not carried out continuously, a person skilled in the art uses sensors for analyzing the quality of the untreated effluent, so as to anticipate situations proficious to membrane clogging.

This strategy is not without difficulty, and has many disadvantages owing to the use of sensors for analyzing effluent quality:
identifying the quality parameters that will signify a situation proficious to fouling is not always easy and is difficult to anticipate;
these parameters may vary qualitatively and quantitatively, depending on the nature of the effluent and the site, and over the course of time;
the cost of the sensors and the cost of processing the signals that they generate; and
the maintenance cost of said sensors.

The Applicant is the proprietor of EP 1 239 943 and WO 01/41906 which describe a chemical microcoagulation method for improving the production capacity of a membrane. This method of membrane microcoagulation consists in injecting, upstream of the membrane, a dose Y of coagulant(s) 30 to 80 times lower, and in a variant 40 to 60 times lower, than the dose X of coagulant(s) bringing the zeta potential of the effluent to zero. In other words, Y is between X/30 and X/80, and in the variant between X/40 and X/60.

Coagulants are known, to a person skilled in the art, to have no membrane cleaning property.

The microcoagulation according to EP 1 239 943 may be implemented continuously, but such implementation is not always necessary or even desirable, and, in all cases, is not technically and economically optimized.

Firstly, when there is no risk of membrane fouling, the implementation of microcoagulation is not strictly necessary and may incur unnecessary coagulant costs. Secondly, bringing the membrane into contact with the coagulant(s) may result over time in membrane degradation.

The object of the invention is in particular to optimize the time over which the microcoagulation is implemented and thus to maintain the lifetime of the membrane, which is of vital technical and economic interest.

One objective of the invention is to optimize the management of membrane microcoagulation implementation—a preventative measure—as a function of operating feedback of the membrane installation, i.e. as a function of just the measurement of the permeability, without having to add additional sensors for measuring effluent quality or the like. Only those sensors which in general are present as standard in membrane installations (for temperature measurement, filtration rate measurement and transmembrane pressure measurement) will be used.

Another objective of the present invention is thus to optimize the implementation of microcoagulation so as to maintain the hydraulic performance of the membrane over the course of time. In this regard, the present invention discloses an optimized, reliable and safe method of controlling a membrane filtration unit and opens the way for a novel concept, namely that of membranes with isoflux and/or isopermeability at a temperature T.

As the prior art has highlighted, a drop in permeability corrected to a reference temperature is the observation indicative of membrane fouling.

Although the membrane microcoagulation described by EP 1 239 943 appears to be a preventive procedure, the inventor has found, quite surprisingly, that the microcoagulation restores the performance of a clogged membrane. Without intervention of microcoagulation, a clogged membrane would require a curative washing phase, namely chemical washing. This particularly surprising observation is completely new.

The resulting management of membrane microcoagulation is just as surprising, by recommending the use of a triggering factor for curative measures (observation of fouling) for successfully implementing preventive measures (membrane microcoagulation).

According to the invention, the method for the optimized management of a membrane filtration unit employing membrane microcoagulation, comprising at least:
measurement of the effluent temperature;
measurement of the filtration rate; and
measurement of the transmembrane pressure, is characterized in that:
injection of the coagulant(s) is started whenever the permeability of the membrane drops below a threshold value; and
injection of the coagulant(s) is stopped when the permeability of the membrane again becomes equal to or greater than the stable permeability value Lp₀ before the drop, for a predetermined hold time.

The membrane permeability may be corrected to a reference temperature and the permeability threshold value is between 10 and 80% of the initial membrane permeability Lpᵢ at said reference temperature, whereas injection of the coagulant(s) is stopped when the membrane permeability, corrected to the reference temperature, again becomes equal to or greater than the stable permeability value Lp₀ before the drop at said reference temperature for a predetermined hold time.

According to another possibility, the threshold value corresponds to a 10 to 40% reduction in the membrane permeability, corrected to a reference temperature, over a fixed time period, and injection of the coagulant(s) is stopped when the membrane permeability, corrected to the reference temperature, again becomes equal to or greater than the stable permeability value Lp₀ before the drop at said reference temperature.

Injection of the coagulant(s) may be started by a drop in the membrane permeability, at the actual temperature of the effluent, below a threshold value of between 10 and 80% of the initial membrane permeability Lpᵢ at said effluent temperature, and injection of the coagulant(s) is stopped when the membrane permeability, at the actual effluent temperature, again becomes equal to or greater than the stable permeability value Lp₀ at the effluent temperature before the drop.

The threshold value may correspond to a 10 to 40% drop in the membrane permeability, at the actual effluent temperature, over a fixed time period and injection of the coagulant(s) is stopped when the membrane permeability, at the actual effluent temperature, again becomes equal to or greater than the stable permeability value Lp₀ at the effluent temperature before the drop.

The reference temperature is generally 20° C. or 25° C.

The fixed time period for the permeability variation may be between 10 minutes and 5 days, preferably between 10 minutes and 60 minutes.

Injection of the coagulant(s) may be stopped when the membrane permeability again becomes, and remains, equal to or greater than the stable permeability value Lp₀ before the drop, for a hold time of greater than 12 hours.

The invention also relates to an installation for the optimized management of a membrane filtration unit with membrane microcoagulation, comprising at least:
measurement of the effluent temperature;
measurement of the filtration rate; and
measurement of the transmembrane pressure,
   for implementing a method as defined above, characterized in that:
it comprises a control unit for controlling the injection of the coagulant(s), connected to the means for measuring the temperature of the effluent, the means for measuring the filtration rate and the means for measuring the transmembrane pressure, this control unit being designed to:
determine the membrane permeability and compare it with a threshold value;
start the injection of the coagulant(s) whenever the membrane permeability drops below the threshold value; and
stop the injection of the coagulant(s) when the membrane permeability again becomes equal to or greater than the stable permeability value Lp₀ before the drop, for a predetermined hold time.

Thus, the result of implementing membrane microcoagulation is that the performance of the membrane, prior to the clogging situation, is restored and maintained.

In particular, the invention proposes to trigger the implementation of microcoagulation upon observation:
of a drop in membrane permeability, at a reference temperature, below a set threshold. Advantageously, this threshold is between 10 and 80% of the initial permeability of the membrane at said reference temperature; and/or
a significant drop in membrane permeability, at a reference temperature, over a given time period. Advantageously, this threshold is set between 10 and 40% of the permeability at said reference temperature over a filtration time period ranging from 10 minutes to 5 days.

A drop in permeability at the temperature of the effluent is indicative of:
membrane fouling; and/or
a drop in temperature.

Apart from the surprising curative effect of implementing membrane microcoagulation, another observation by the inventor is that the effect of improving the hydraulic performance of the membrane may advantageously be exploited so as to compensate for the negative effect of a temperature drop on the hydraulic performance of the membrane, an application which has never been described. In this regard, by judicious implementation of microcoagulation it is possible, surprisingly and in a novel manner, to circumvent a fundamental law of physics hitherto suffered by membrane technology operators.

The implementation of microcoagulation, thus triggered/controlled, makes it possible according to the present invention to eliminate the negative effect of a drop in temperature and/or of an increase in the clogging character of the effluent.

The management of membrane microcoagulation, optimized according to the present invention, thus makes it possible to maintain the hydraulic performance whatever the temperature of the effluent and/or the variations in clogging character thereof.

The management of membrane microcoagulation, optimized according to the present invention, allows relevant discontinuous operation of said method and enables the implementation of said method to be judiciously restricted only to periods when it is necessary to implement it. Thus, this method of management makes it possible to save on coagulants and advantageously maintains the lifetime of the membrane.

Another advantage of the present invention is that it does not require the addition of any equipment not already existing on membrane filtration installations, namely that for measuring the temperature of the effluent, the filtration rate and the transmembrane pressure from which the permeability at the temperature of the effluent and/or at a reference temperature is calculated.

By so doing, the present invention does not incur any investment or maintenance cost for additional sensors, nor does it involve the always difficult choice of said sensors, which are specific to each site, depending on the nature of the effluent, thereby complicating the exercise.

Apart from the arrangements presented above, the invention consists of a number of other arrangements which will be more explicitly given below with regard to exemplary embodiments, described with reference to the appended drawings but in no way limiting. In these drawings:

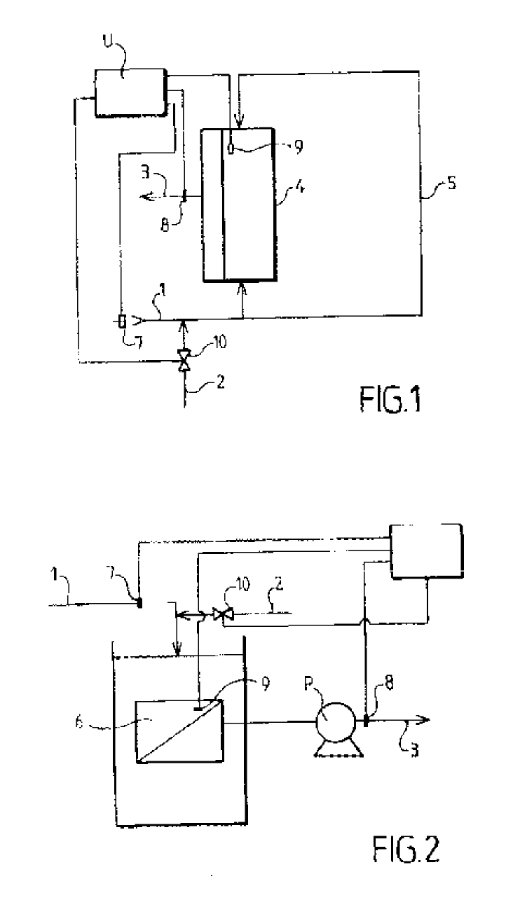

FIG. 1 is a diagram of an installation for implementing the method according to the invention using an encased circulation-type membrane;

FIG. 2 is a diagram of an installation for implementing the method according to the invention using an immersed free membrane;

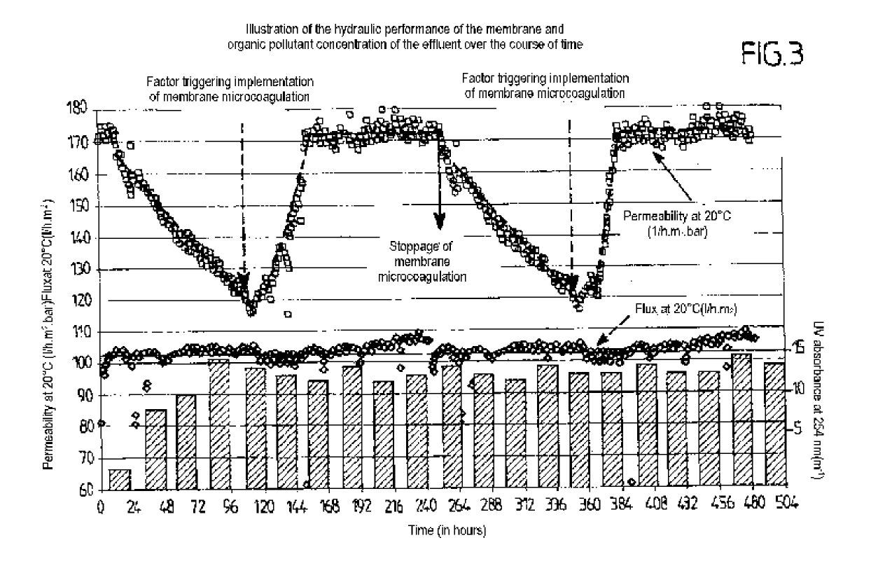

FIG. 3 is a plot illustrating the variation in the hydraulic performance of a membrane and in the organic pollutant concentration of the effluent over the course of time, according to Example 1; and

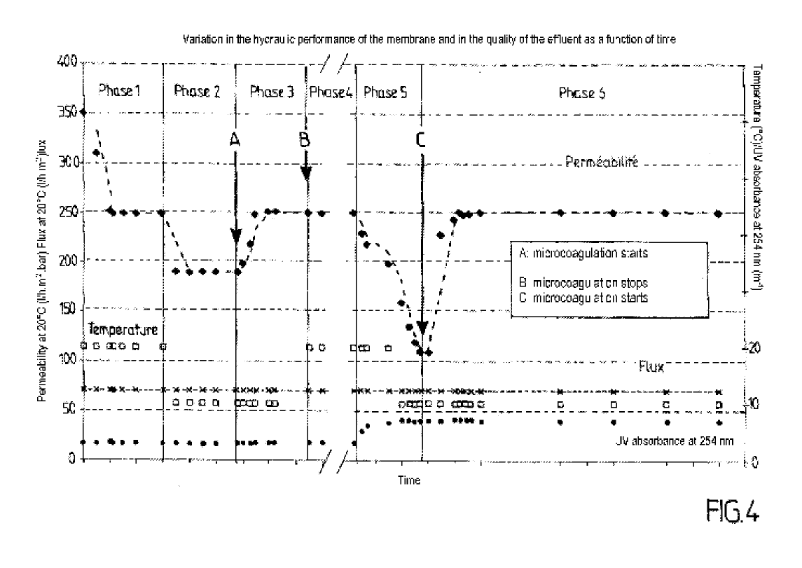

FIG. 4 is a plot illustrating the variation in the hydraulic performance of a membrane and in the quality of the effluent as a function of time, according to Example 2.

In FIGS. 1 and 2, identical or similar elements have been denoted by the same references.

In the installation shown in FIG. 1, the coagulant is injected at 2, upstream of the membrane, into the untreated water 1. The untreated water/coagulant mixture is then filtered over the encased membrane 4. The installation optionally includes a recirculation loop 5. The treated water 3 leaves via a line.

In the installation shown in FIG. 2, the coagulant is injected at 2, upstream of the membrane, into the untreated water 1. The untreated water/coagulant mixture is then filtered over the free membrane 6 immersed in a basin containing the untreated water. The treated water 3 is discharged by means of a pump P.

The dose Y of coagulant(s) injected into the untreated water 1, upstream of the membrane, is 30 to 80 times lower, and as a variant 40 to 60 times lower, than the dose X of coagulant bringing the zeta potential of the untreated water 1 to zero. Therefore, Y is between X/30 and X/80, and in the variant between X/40 and X/60.

The installation includes a control unit U, consisting in particular of a programmable controller or computer. Connected to this unit U are measurement sensors for transmitting information about operating parameters to said unit.

In particular, the installation includes at least:
a sensor 7 for measuring the temperature of the effluent 1;
a sensor 8 for measuring the filtration rate, fitted on the pipe for discharging the treated water 3; and
one or more sensors 9 for measuring the transmembrane pressure.

The outputs of these sensors are connected to the unit U which determines, from the measurement results provided, the instantaneous permeability of the membrane.

A valve 10, fitted on the coagulant feed line 2, is controlled by the unit U in which a program, constituting the injection control means, is installed, whereby:
injection of the coagulant(s), by opening the valve 10, is started whenever the permeability of the membrane, optionally corrected to a reference temperature, drops below a threshold value of between 10 and 80% of the initial permeability of the membrane at said reference temperature; and
injection of the coagulant(s) is stopped, by closing the valve 10, when the permeability of the membrane, corrected to a reference temperature, again becomes equal to or greater than the stable permeability value Lp₀ before the drop, for a predetermined hold time.

This hold time is preferably greater than 12 hours and the reference temperature is generally 20° C. or 25° C.

According to a variant, the threshold value corresponds to a 10 to 40% reduction in the membrane permeability, optionally corrected to a reference temperature, over a fixed time period, and injection of the coagulant(s) is stopped when the membrane permeability, optionally corrected to the reference temperature, again becomes equal to or greater than the permeability value Lp₀ before the drop.

The fixed time period for the variation of the permeability triggering the implementation of microcoagulation is generally between 10 minutes and 5 days, and advantageously between 10 minutes and 60 minutes.

### EXAMPLE 1

Example of optimized management of membrane microcoagulation implementation based on measurement of the permeability at 20° C.

This first example relates to the filtration of karst water by an industrial ultrafiltration unit having a production capacity of 2000 m³ per day. This is an encased membrane of the hollow-fiber type, the initial permeability Lpᵢ of which at 20° C. is 300 l/h·m²·bar measured on drinking water having a clogging index (i.e. an SDI) of 5%/min measured according to the ASTM D 4189.95 standard.

FIG. 3 illustrates the variation in the hydraulic performance of the membrane as a function of time, plotted on the x-axis and expressed in hours, and the organic pollutant concentration. The permeability at 20° C., expressed in l/h·m²·bar, is plotted on the y-axis with the gradations on the left-hand scale. The flux at 20° C., expressed in l/h·m², is plotted on the y-axis with the gradations on the left-hand scale. The UV absorbance at 254 nm (in m⁻¹) of the untreated effluent is plotted on the y-axis with the gradations on the right-hand scale and is represented by vertical bands corresponding to the measurement periods (specimens averaged over 24 hours).

The resource, the characteristics of which are summarized in Table 1 below, is a cold water (at a temperature of 8° C.), of low turbidity, which, for reasons poorly understood at the present time, is subject to sudden increases in organic pollution during rainy episodes. This pollution is illustrated by a very substantial increase in the UV absorbance measured at 254 nm, to greater than 15 m⁻¹, indicative of an increase in the concentration of large unsaturated organic molecules. Outside rainy episodes, the UV absorbance measured at 254 nm is relatively constant at a level of 2 to 4 m⁻¹.

TABLE 1
Characteristics of the effluent

| | Minimum | Maximum |
|---|---|---|
| | value | value |
| pH | 7.5 | 7.9 |
| Temperature (° C.) | 7.5 | 8.5 |
| Turbidity (NTU) | 0.5 | 21.0 |
| UV₂₅₄ₙₘ absorbance (m⁻¹) | 2.2 | 15.5 |
| TOC (mg C/l) | 1.0 | 7.0 |

Outside rainy episodes, the hydraulic performance of the membrane is stable and satisfactory with a permeability Lp₀ at 20° C. ranging from 170 to 175 l/h·m²·bar for an applied filtration flux at 20° C. of 105-110 l/h·m², not requiring implementation of the membrane microcoagulation method.

In contrast, during rainy episodes, the sudden increase in organic pollution results in membrane clogging, manifested by a drop in permeability while the filtration flux at 20° C. is kept constant at 105 l/h·m² and the water temperature kept constant at 8° C.

Within the context of this example, around the 108th hour, implementation of microcoagulation is triggered when the permeability at 20° C. has dropped to the threshold value of 120 l/h·m², i.e.:
a threshold value equivalent to 34% ( 120/350) of Lpᵢ;
or else a 30% drop at 96 h from the stable permeability Lp₀ at 20° C. of 170 l/h·m², corresponding to substantial clogging of the membrane.

Very surprisingly, a rapid restoration of the permeability is then observed, returning, at around the 150th hour, to a level similar to the permeability measurement Lp₀ before degradation of the resource (i.e. 170-175 l/h·m²·bar at 20° C.), whereas the flux is kept constant and the level of organic pollution of the resource remains extremely high.

After a hold time of about 100 hours with the permeability substantially at its stable value Lp₀ before the drop, the microcoagulation is stopped.

Very surprisingly, when the microcoagulation is stopped at about 250 h of operation, the permeability does not drop suddenly to its lowest level observed previously. In contrast, a rate of fouling similar to that of an unfouled membrane is observed, indicative of a curative effect of implementing membrane microcoagulation.

The microcoagulation is reapplied at around the 350th hour and similar impacts on the variation in permeability are repeated.

This management of membrane microcoagulation is particularly relevant on this site. This is because, taking into account the small size of the installation, it is entirely automated and no permanent staff are assigned to the site. Situated in the mountains, the installation is also difficult to access.

The automated management of microcoagulation implementation according to the present invention therefore makes it possible to restore and maintain the hydraulic performance of the membrane without human intervention and “compensate” for clogging which would, without intervention, have required the operator to carry out a chemical washing operation.

Furthermore, given the size of the installation, the cost of operating resource quality sensors for regulating the operation of said method would have a significant impact on the cost of the installation. Moreover, to maintain said sensors would have required the use of resources and skills that have not at the present time been assigned to this installation.

### EXAMPLE 2

Example of optimized management of membrane microcoagulation based on measurement of the permeability at T, the actual temperature of the effluent.

The example given below relates to a trial carried out on a pilot ultrafiltration unit using an internal-skin hollow-fiber organic membrane module from Aquasource.

The initial permeability Lpᵢ of the membrane at 20° C. is 350 l/h·m²·bar, i.e. after temperature correction about 270 l/h·m²·bar at 10° C. (measurement carried out on drinking water with an SDI of 6%/min according to the ASTM D 4189.95 standard).

The experiment was carried out on water from the river Seine, the temperature of which was naturally 20° C., and periodically cooled down to 10° C. using a chiller for the purposes of the experiment.

The quality of the Seine water during the trial was the following:

TABLE 2
Characteristics of the Seine water during the trial

| | Minimum | Maximum |
|---|---|---|
| | value | value |
| pH | 7.5 | 7.9 |
| Temperature (° C.) | 10 | 20 |
| Turbidity (NTU) | 3.0 | 15.0 |
| UV_{254 nm} absorbance (m⁻¹) | 3.0 | 7.0 |
| TOC (mg C/l) | 3.0 | 5.0 |

The results of the experiment, commented upon below, are illustrated in FIG. 4. Throughout the trial, the flux applied to the membrane was constant and set at 70 l/h·m² at temperature T. The flux measurement points are indicated by crosses in FIG. 4. The temperature measurement points are indicated by squares, whereas the absorbance measurement points are indicated by filled circles and the permeability measurement points are indicated by diamonds.

In FIG. 4, the time is plotted on the x-axis. The permeability at T° C., expressed in l/h·m²·bar, is plotted on the y-axis with gradations on the left-hand scale. The flux at T° C., expressed in l/h·m², is plotted on the y-axis with gradations on the left-hand scale. The UV absorbance at 254 mm (in m⁻¹) of the untreated effluent is plotted on the y-axis with gradations on the right-hand scale. The temperature is plotted on the y-axis with gradations on the right-hand scale.

During phase 1, the effluent temperature is 20° C. and the membrane is fresh. Owing to the nature of the water, the permeability of the membrane naturally drops from its initial value Lpᵢ at 20° C. of 350 l/h·m²·bar, stabilizing to a value Lp₀ at 20° C. of 250 l/h·m²·bar, i.e. in this case a drop of about 71% from the initial permeability of the membrane at 20° C. (250 u 0.71×350).

During phase 2, the Seine water is cooled using a chiller down to a temperature of 10° C. The impact of the drop in temperature on the viscosity of the water therefore results in a progressive drop in permeability by around 23 to 25% in accordance with the prior art, whereas the characteristics of the Seine water, in particular the level of organic pollution, remain constant. The permeability measurement therefore stabilizes at temperature T to a level of 190 l/h·m²·bar.

At this stage, membrane microcoagulation according to the invention is implemented during phase 3 of the trial. The inventor then observed a restoration in performance of the membrane at 10° C. to a level similar to that obtained for an effluent at 20° C. The permeability at 20° C. in the absence of microcoagulation is therefore similar to the permeability at 10° C. with membrane microcoagulation, i.e. 250 l/h·m²·bar.

At this stage of the experiment, the effluent cooling was stopped and membrane microcoagulation suspended for around fifteen days (phase 4) with the expectation of natural degradation in the quality of the resource.

During phase 5, this degradation occurred with an increase in organic pollution, an increase in the TOC value from 3 to 5 mg C/l and an increase in UV absorbance at 254 nm 3-4 m⁻¹ to 5-7 m⁻¹. Such variations in this resource, well known to the inventor, are indicative of a real increase in the clogging capability of the effluent.

In fact, a drop in permeability is observed and the effluent cooling carried out further accentuates this drop in permeability. When the permeability measurement at 10° C. reaches the value 110 l/h·m²·bar, i.e. a threshold value equal to 40% (110 u 0.4×270) of the initial permeability Lpᵢ of the membrane at 10° C., the microcoagulation according to the invention is triggered.

FIG. 4 therefore illustrates the surprising restoration of the membrane permeability at 10° C. to 250 l/h·m²·bar, at the temperature of the effluent, with thereafter the performance maintained at a level similar to that obtained with a less-clogging water and at a considerably higher temperature, throughout the duration of phase 6 of the trial.

This example illustrates the potential of managing triggering of membrane microcoagulation on the basis of the permeability at the actual temperature of the effluent, eliminating and thus compensating the effects of clogging and/or of the drop in temperature.

This method of management opens up new prospects for stabilizing the operation of an ultrafiltration unit and tends toward operation under isoflux and isopermeability throughout the year.

The invention does not involve specifically stopping the production process, except for alternating filtration/backwashing operations. The coagulants employed are not washing agents, nor do they have oxidizing or disinfecting properties.

1. A method for the optimized management of a membrane filtration unit employing membrane microcoagulation, which microcoagulation consists in injecting, upstream of the membrane, a dose of coagulant(s) 30 to 80 times lower than the dose bringing the zeta potential of the effluent to zero, comprising at least:
measurement of the effluent temperature;
measurement of the filtration rate; and
measurement of the transmembrane pressure,
wherein:
injection of the coagulant(s) is started whenever the permeability of the membrane drops below a threshold value; and
injection of the coagulant(s) is stopped when the permeability of the membrane again becomes equal to or greater than the stable value Lp₀ before the drop, for a predetermined hold time.

2. The method as claimed in claim 1, wherein the membrane permeability is corrected to a reference temperature and the permeability threshold value is between 10 and 80% of the initial membrane permeability Lpᵢ at said reference temperature, whereas injection of the coagulant(s) is stopped when the membrane permeability, corrected to the reference temperature, again becomes equal to or greater than the stable value Lp₀ before the drop at the reference temperature for a predetermined hold time.

3. The method as claimed in claim 1, wherein the threshold value corresponds to a 10 to 40% reduction in the membrane permeability, corrected to a reference temperature, over a fixed time period, and injection of the coagulant(s) is stopped when the membrane permeability, corrected to the reference temperature, again becomes equal to or greater than the stable value Lp₀ before the drop at the reference temperature.

4. The method as claimed in claim 1, wherein injection of the coagulant(s) is started by a drop in the membrane permeability, at the actual temperature of the effluent, below a threshold value of between 10 and 80% of the initial membrane permeability Lpᵢ at said effluent temperature, and injection of the coagulant(s) is stopped when the membrane permeability, at the actual effluent temperature, again becomes equal to or greater than the stable value Lp₀ at the effluent temperature before the drop.

5. The method as claimed in claim 1, wherein the threshold value corresponds to a 10 to 40% drop in the membrane permeability, at the actual effluent temperature, over a fixed time period and injection of the coagulant(s) is stopped when the membrane permeability, at the actual effluent temperature, again becomes equal to or greater than the stable value Lp₀ at the effluent temperature before the drop.

6. The method as claimed in claim 2, wherein the reference temperature is 20° C. or 25° C.

7. The method as claimed in claim 3, wherein the fixed time period for the permeability variation is between 10 minutes and 5 days.

8. The method as claimed in claim 7, wherein the fixed time period for the permeability variation is between 10 and 60 minutes.

9. The method as claimed in claim 1, wherein injection of the coagulant(s) is stopped when the membrane permeability again becomes, and remains, equal to or greater than the stable value Lp₀ before the drop, for a hold time of greater than 12 hours.

10. An installation for the optimized management of a membrane filtration unit with membrane microcoagulation, which microcoagulation consists in injecting, upstream of the membrane, a dose of coagulant(s) 30 to 80 times lower than that bringing the zeta potential of the effluent to zero, comprising at least:
measurement of the effluent temperature;
measurement of the filtration rate; and
measurement of the transmembrane pressure,
for implementing a method as claimed in any one of the preceding claims, wherein:
it comprises a control unit (U) for controlling the injection of the coagulant(s), connected to the means (7) for measuring the temperature of the effluent, the means (8) for measuring the filtration rate and the means (9) for measuring the transmembrane pressure, this control unit being designed to:
determine the membrane permeability and compare it with a threshold value;
start the injection of the coagulant(s) whenever the membrane permeability drops below the threshold value; and
stop the injection of the coagulant(s) when the membrane permeability again becomes equal to or greater than the stable value Lp₀ before the drop, for a predetermined hold time.
